(19) United States
(12) Patent Application Publication
(10) Pub. No.: US 2002/0064358 A1
(43) Pub. Date: May 30, 2002

(54) Component having reduced cross talk

(76) Inventor: Chi Wu, San Marino, CA (US)

Correspondence Address: Terrance A. Meador, Gray Cary Ware & Freidenrich, Suite 1600, 4365 Executive Drive, San Diego, CA, 92121-2189, US

(21) Appl. No.: 09/784,814

(22) Filed: Feb. 15, 2001

Related U.S. Application Data
(63) Continuation-in-part of application No. 09/723,764, filed on Nov. 28, 2000.
(60) Provisional application No. 60/239,534, filed on Oct. 10, 2000.

(51) Int. Cl. G02B 6/122; G02B 6/26

(52) U.S. Cl. 385/129; 385/50

(57) ABSTRACT

An optical component is described. The optical component includes a base and a plurality of waveguides defined in a light transmitting medium. The light transmitting medium is positioned adjacent to the base such that the light transmitting medium associated with at least two adjacent waveguides is separated by a gap.

### RELATED APPLICATIONS

This application is a continuation-in-part of U.S. patent application Ser. No. 09/723,764, filed on Nov. 28, 2000, entitled “Silica Waveguide” and incorporated herein in its entirety which claims the benefit of U.S. Provisional Application No. 60/239,534, filed on Oct. 10, 2000, entitled “A Compact Integrated Optics Based Array Waveguide Demultiplexer” and incorporated herein in its entirety.

This application is related to U.S. patent application Ser. No. 09/724,175, filed on Nov. 28, 2000, entitled “A Compact Integrated Optics Based Array Waveguide Demultiplexer” and U.S. patent application Ser. No. 09/724,173, filed on Nov. 28, 2000, entitled “Demultiplexer Having a Compact Light Distributor” of which both applications are incorporated herein in their entirety.

### BACKGROUND

1. Field of the Invention

The invention relates to one or more optical networking components. In particular, the invention relates to components having increased tolerance to handling.

2. Background of the Invention

Many components for optical networking include a plurality of waveguides formed on a substrate. The components often include a light barrier or cladding layer positioned over the substrate. A layer of a light carrying medium positioned adjacent to the light barrier or cladding layer is formed into a plurality of ridges. The ridges serve as the waveguides where light signals are carried. The light barrier or cladding layer is a continuous layer that is positioned under each of the waveguides. The light barrier or cladding layer prevents light from the waveguides from leaking into the substrate. However, when light escapes from one of the waveguides, the light barrier or cladding layer traps the light within the light carrying medium. The trapped light can enter into other waveguides on the component. Light entering one waveguide from another waveguide is the source of cross talk on the component. There is a need for optical components having reduced cross talk.

### SUMMARY OF THE INVENTION

The invention relates to an optical component. The optical component includes a base and a plurality of waveguides defined in a light transmitting medium. The light transmitting medium is positioned adjacent to the base such that the light transmitting medium associated with at least two adjacent waveguides is separated by a gap.

The gap can contain a medium that causes a light signal from the light transmitting medium to be reflected back into the adjacent light transmitting medium. In some instances, the medium in the gap is ambient air.

Another embodiment of the optical component includes a base and a light transmitting medium positioned adjacent to the base. At least one waveguide having a longitudinal length is defined in the light transmitting medium. The light transmitting medium includes a surface that intersects with the base and extends along at least a portion of the longitudinal length of the waveguide. In some instances, the surface intersects the base at a location remote from the at least one lateral side.

The invention also relates to a method of fabricating an optical component. The method includes obtaining a base and a light transmitting medium positioned adjacent to the base. A waveguide is defined in the light transmitting medium. The method also includes forming a surface in the light transmitting medium that intersects the base. The surface extends along at least a portion of a longitudinal length of the waveguide.

Another embodiment of the method includes obtaining a base with a light transmitting medium positioned adjacent to the base. The method also includes forming a surface in the light transmitting medium such that at least a portion of the surface intersects with the base. The method further includes defining a waveguide in the light transmitting medium such that the surface extends along at least a portion of a longitudinal length of the waveguide. Defining the waveguide in the light transmitting medium can include forming a ridge in the light transmitting medium.

The act of obtaining components can include receiving the components from a supplier.

### BRIEF DESCRIPTION OF THE FIGURES

FIG. 1A is a topview of a portion of a component having a waveguide

FIG. 1B is a cross section of the portion of the component illustrated in FIG. 1A taken at the line labeled A.

FIG. 2 illustrates a light transmitting medium formed in a pocket of a component.

FIG. 3A illustrates an optical component having a ridge positioned in a pocket.

FIG. 3B illustrates an optical component having a ridge extending into a pocket. A light transmitting medium is formed in the pocket.

FIG. 3C illustrates an optical component having a first ridge extending into a pocket and a second ridge extending away from the pocket.

FIG. 4A through FIG. 4C illustrate an optical component having an alignment region configured to provide alignment between an optical fiber and a facet of a waveguide.

FIG. 4D through FIG. 4F illustrate the alignment region providing alignment between the facet and an optical fiber.

FIG. 4G illustrates a waveguide ending in a facet that is angled at less than ninety degrees relative to a longitudinal axis of the waveguide. The facet is perpendicular to the top side of the waveguide.

FIG. 4H illustrates a component having a plurality of waveguides that each end in a facet. The angle of the facet on a waveguides is the opposite of the angel on the adjacent facet.

FIG. 5A is a cross section of a component having a plurality of waveguides.

FIG. 5B is a top view of a component having a plurality of waveguides. Each waveguide is illustrated as being associated with an independent pocket.

FIG. 5C is a top view of component having a plurality of waveguides where a pocket is associated with more than one waveguide.

FIG. 6A is a cross section of a component having a plurality of waveguides formed over a base. The waveguides are formed of a light transmitting medium that includes one or more surface that intersect the base at a location remote from lateral sides of the base.

FIG. 6B is a topview of the component shown in FIG. 6A.

FIG. 6C is a cross section of a component having a plurality of waveguides formed over a base. The waveguides are formed of a light transmitting medium that includes one or more surface extending from the base away from the base. The base includes a second light transmitting medium formed over a substrate.

FIG. 6D illustrates a component having a plurality of waveguides formed over a base. The base includes a light barrier positioned over a substrate. The waveguides are formed of a light transmitting medium that includes one or more surface that intersect the base at a location remote from lateral sides of the base.

FIG. 7A through FIG. 7F illustrates a method for forming a component according to the present invention.

FIG. 8A through FIG. 8F illustrate a method of forming an optical component having a ridge positioned in a pocket.

FIG. 9A through FIG. 9H illustrate a method of forming an optical component having an alignment region configured to align an optical fiber with a facet of a waveguide.

FIG. 10A through FIG. 10I illustrate another embodiment of a method for forming an optical component having an alignment region configured to align an optical fiber with a facet of a waveguide.

FIG. 11A through FIG. 11M illustrate method of forming an optical component having a waveguide with an angled facet.

FIG. 12A through FIG. 12E illustrate a method for forming a pocket having a gas under vacuum.

FIG. 13 illustrates an optical component having supports for supporting the waveguide over a pocket.

### DETAILED DESCRIPTION OF THE PREFERRED EMBODIMENT

An optical component is described. The optical component includes a base and a plurality of waveguides defined in a light transmitting medium. The light transmitting medium is positioned adjacent to the base such that the light transmitting medium associated with at least two adjacent waveguides is separated by a gap. The gap holds a medium that causes light signals from the light transmitting medium to be reflected back into the light transmitting medium. For instance, light signals that escape from a waveguide and are incident on the gap are reflected back into the light transmitting medium associated with the waveguide from which the light signal escaped. As a result, the escaped light signal does not enter adjacent waveguides and is not a source of cross talk.

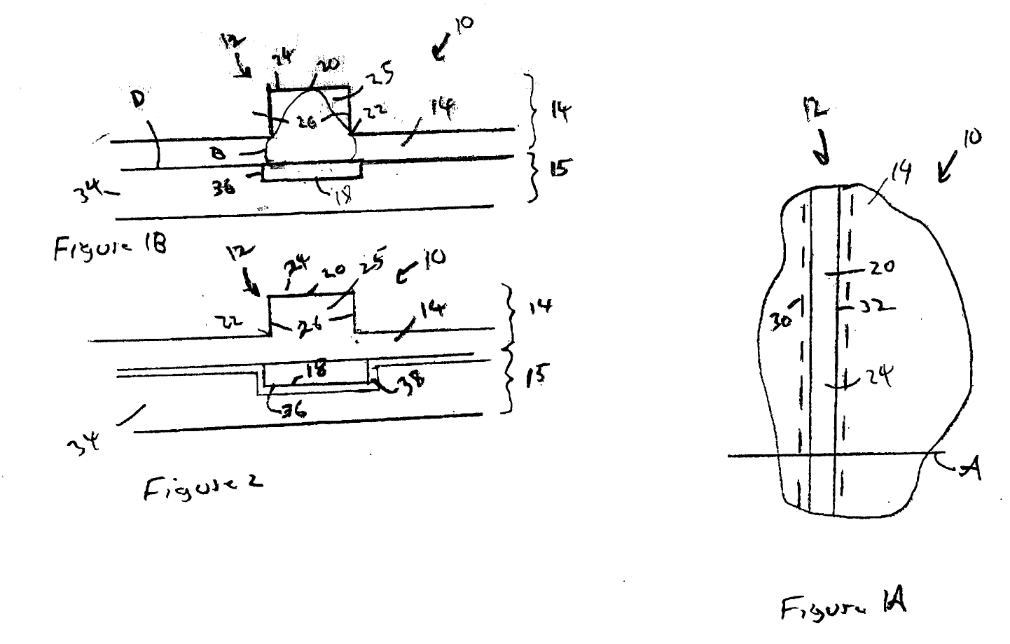

FIG. 1A is a topview of a portion of a component having a waveguide. FIG. 1B is a cross section of the portion of the component 10 illustrated in FIG. 1A taken at the line labeled A. The component 10 includes a light transmitting medium such as a silica material 14 formed over a base 15. The base 15 includes one or more surface 36 that define a pocket. The silica material 14 is formed into a ridge having a base 22, a top 24 and opposing sides 26. The ridge defines a portion of a light signal carrying region 25. The profile a light signal being carried in the light signal carrying region is illustrated by the line labeled B.

The pocket can hold a material that reflects light signals from the light signal carrying region back into the light signal carrying region. For instance, the pocket can hold a gas such as air or another medium with an index of refraction that is less than the index of refraction of silica. The drop in index of refraction causes reflection of a portion of the light signals that are incident on the material in the pocket. Accordingly, the material in the pocket restrains the light signals to the light signal carrying region.

FIG. 1A shows the periphery of the pocket 30 relative to the periphery of the ridge 32. The periphery of the pocket 30 is illustrated as a dashed line. The ridge is positioned over the pocket and the periphery of the pocket 30 traces the periphery of the ridge 32. For instance, the distance between the ridge base 22 and the periphery of the pocket 30 can be substantially constant along the length of at least a portion of the waveguide.

The pocket and the ridge can be constructed such that the periphery of the pocket 30 extends beyond the periphery of the ridge 32. In some instances, the pocket and waveguide 12 are constructed such that the periphery of the pocket 30 is substantially the same size as the periphery of the ridge 32. In other instances, the pocket and the ridge are constructed such that the periphery of the pocket 30 is smaller than the periphery of the ridge 32.

In some instances, the width of the pocket is larger than 200% of the width of the ridge base 22. In other instances, the width of the pocket is less than 200% of the ridge base 22 width, less than 150% of the ridge base 22 width, less than 140% of the ridge base 22 width, less than 130% of the ridge base 22 width, less than 120% of the ridge base 22 width, less than 110% of the ridge base 22 width, less than 100% of the ridge base 22 width. When a pocket is employed with another type of waveguide, the pocket can have the same dimensional relationships to the width of the waveguide 12 that is employed with respect to the ridge.

The base 15 can include a substrate 34 such as a silicon substrate 34. As shown in FIG. 1A, the substrate 34 can have one or more surface 36 that define a pocket 18 in the substrate 34. Alternatively, one or more layers of a light transmitting medium 38 such as silica can be formed in the pocket 18 as shown in FIG. 2.

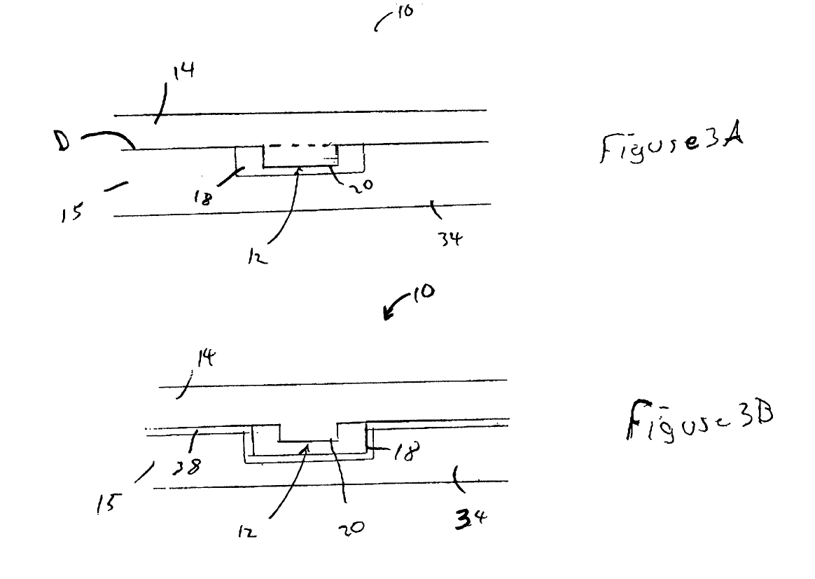

The ridge 20 can be inverted so the ridge 20 is positioned in the pocket 18 as shown in FIG. 3A. Positioning the ridge 20 in the pocket 18 protects the ridge 20 from physical damage. For example, the position of the ridge 20 in the pocket 18 can protect the ridge 20 from damage that can occur during the handling of the component 10. A light transmitting medium 38 can be formed in the pocket as shown in FIG. 3B.

The light transmitting medium can have a first ridge 20A that extends into the pocket 18 and a second ridge 20B that extends away from the pocket 18 as illustrated in FIG. 3C. The first ridge 20A can have the same or a different shape than the second ridge 20B. For instance, the second ridge 20B can be wider, narrower, taller and/or shorter than the first ridge 20A.

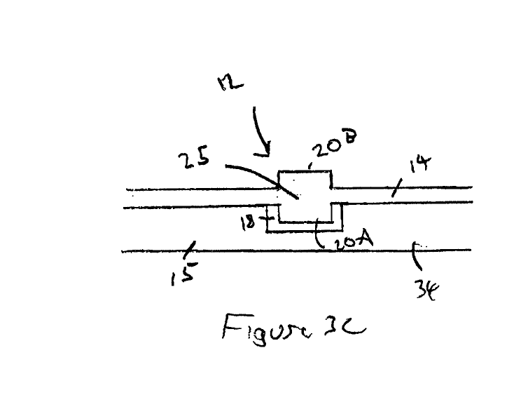

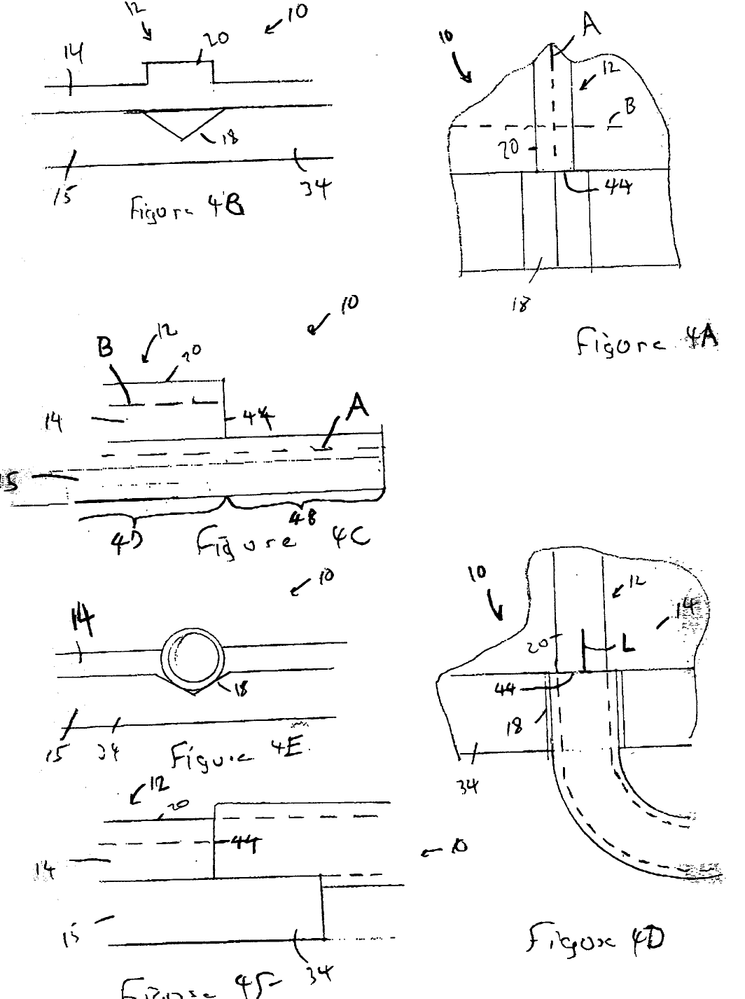

The light signal carrying regions of the waveguides on the component can end at a facet. The pocket can serve to align an optical fiber with the facet. For instance, FIG. 4A through FIG. 4C illustrate a component 10 having an alignment region 48 for aligning an optical fiber 46 with a facet 44. FIG. 4A is a topview of an optical component 10 having an alignment region 48. FIG. 4B is a cross section of FIG. 4A taken at the line labeled B. FIG. 4C is a cross section of the component 10 illustrated in FIG. 4A taken along the line labeled A. The dashed line labeled A in FIG. 4A shows the location of the bottom of the pocket while the dashed line labeled B shows the location of the base of the ridge.

The base 15 includes a support region 47 adjacent to an alignment region 48. The light transmitting medium 38 is positioned over the support region 47 but not positioned over the alignment region 48. The alignment region 48 is positioned adjacent to the facet 44 and extends away from the support region 47 at a substantially right angle relative to the facet 44. The pocket 18 extends from under the light signal carrying region 25 and into the alignment region 48.

The alignment region 48 is configured to align the optical fiber 46 in a desired orientation relative to the facet 44 as illustrated in FIG. 4D through FIG. 4F. FIG. 4D through FIG. 4F correspond to FIG. 4A through FIG. 4C with the optical fiber 46 received within the pocket 18. The illustrated optical fiber 46 has a cladding although the alignment region can be employed in conjunction with optical fibers without a cladding. The position of the cladding relative to the waveguide 12 is illustrated by a dashed line.

The pocket 18 is sized so as to receive the optical fiber 46 such that the optical fiber 46 has a particular orientation relative to the facet 44. For instance, the pocket 18 can be centrally positioned relative to the facet 44. Accordingly, when the optical fiber 46 is positioned in the pocket 18, the center of the optical fiber 46 is aligned with the center of the facet 44. The depth of the pocket 18 can be selected to position the height of the optical fiber 46 relative to the waveguide 12. For instance, a deeper and wider pocket 18 causes the optical fiber 46 to sit lower relative to the waveguide 12 while a narrow shallow pocket 18 can raise the optical fiber 46 relative to the waveguide 12.

Although the pocket 18 in the self-alignment region 48 is shown as having a v-shape, the pocket 18 can have other shapes that provide self-alignment. For instance, the pocket 18 can have a semi-circular shape with the deepest part of the semi-circle centered relative to the facet. The semi-circle can have a shape that is complementary to the shape of the optical fiber 46 so the optical fiber fits snugly in the pocket 18. A pocket 18 that is snug on the optical fiber 46 reduces the possible range of movement of the optical fiber 46 relative to the waveguide 12.

Although the pocket is shown as having a substantially rectangular shape, the pocket can have other shapes including, but not limited to, semi-circular, semi-oval and a v-shape. FIG. 4A illustrates a component 10 having a v-shaped pocket 18.

An optical fiber can be coupled with the facet by positioning an index of refraction matching oil and/or an index of refraction matching epoxy between the facet and the optical fiber. Additionally, the optical fiber can be coupled with the pocket to further immobilize the optical fiber relative to the alignment region.

The discussion of the alignment region presumes that the optical fiber is preferably centered relative to the facet, however, the alignment region can also be configured to align an optical fiber such that the optical fiber is not centered relative to the waveguide.

Although the above discussion of the alignment region is directed toward waveguides having a ridge that extends away from the pocket, the alignment region can also be associated with waveguides having a ridge that extends into the pocket.

FIG. 4A through FIG. 4F illustrate the facet 44 as being perpendicular to a longitudinal axis, L, of the waveguide 12 at the end of the waveguide. However, the facet 44 can be angled relative to the longitudinal axis L as shown by the angle labeled θ in FIG. 4G. The facet is substantially perpendicular relative to the base. The angle can cause light that is reflected by the facet to be reflected out of the waveguide as illustrated by the arrow labeled A. Directing the reflected light out of the waveguide prevents the reflected light from resonating within the waveguide and accordingly improves performance of the waveguide.

Reducing the angle θ can result in increased insertion losses. As a result, there is a balance between increased insertion losses and reduced resonance. Suitable angles θ include, but are not limited to, less than 90 degrees, less than 89 degrees, 45-90 degrees, 60-89 degrees, 70-88 degrees, 80-87 degrees, 81-86 degrees, 81.5-84.5 degrees, 82-84 degrees or 82.5-83.5 degrees.

When a component includes a plurality of waveguides, the direction of the facet angle on adjacent waveguides can be alternated so as to provide a zig zag configuration of facets as illustrated in FIG. 4H. The component can also be constructed so the facet direction is alternated less frequently than every facet. The angle θ is presumed to be an absolute value measurement, in that a facet positioned at an angle of 271 degrees relative to the longitudinal axis is presumed to be positioned at an angle of 89 degrees. Accordingly, each of the facets in FIG. 4H are considered to have the same angle θ although they are angle in opposing directions.

When the waveguide facet 44 is angled, the optical fiber also has a facet that is angled relative to the longitudinal axis of the optical fiber. The angle of the optical fiber facet is complementary to the angle of the facet on the waveguide. The complementary angles allow the optical fiber to be coupled to waveguide with the longitudinal axis of the waveguide aligned with the longitudinal axis of the optical fiber.

Although the angled facet discussed above is disclosed in conjunction with an alignment region, an angled facet can be formed at an edge of a component when an alignment region is not formed. Further, the component can include angled facets when the ridge extends into the pocket.

As discussed above, the pocket 18 can be filled with a gas such as air. When the pocket is filled with a gas, the gas can be under vacuum. The vacuum serves to provide thermal insulation to the waveguide and can increase reflection of the light signals from the light signal carrying region. Alternatively, the pocket 18 can be filled with a material having an index of refraction less than the index of refraction of the light transmitting medium. For instance, when the light transmitting medium is a silica material, the pocket 18 can be filled with a low dielectric constant, K, material having an index of refraction that is less than the index of refraction of silica. Suitable low K materials have a K less than about 1.5. Examples of low K materials include, but are not limited to, SiCOH. The pocket can also be filled with a material having reflective properties. For instance, the pocket can be filled with a reflective metal. When the light signal carrying medium is formed of a light transmitting medium other than silica, the low K material has an index of refraction less than the index of refraction of the light transmitting medium.

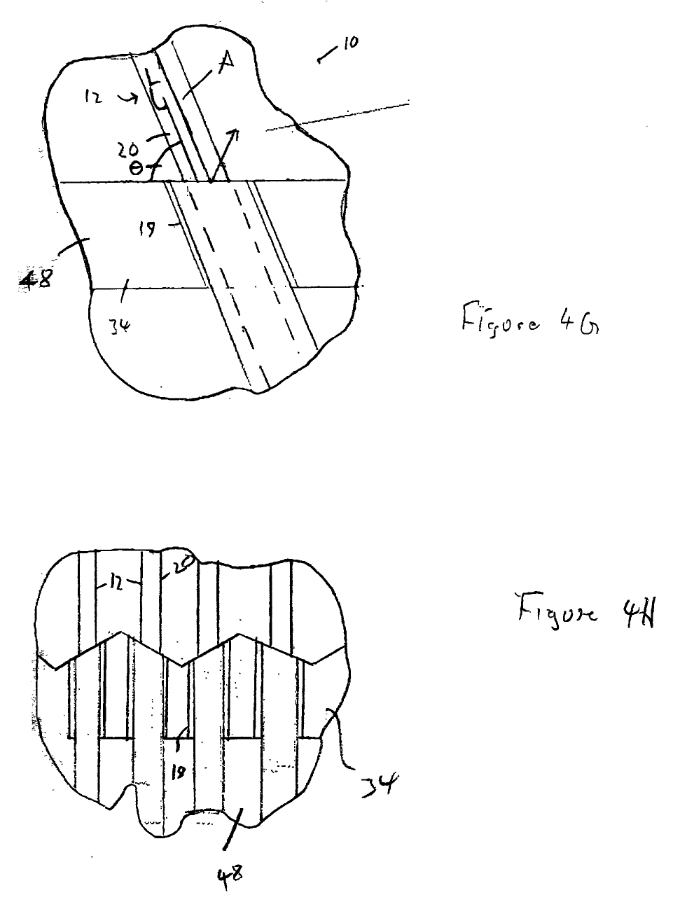

Although FIG. 1A through FIG. 4G illustrate a component 10 having a single waveguide, the component 10 can include a plurality of waveguides as shown in FIG. 5A. An example of an optical component 10 including a plurality of waveguides is a demultiplexer having an arrayed waveguide grating.

A different pocket 18 can be associated with each waveguide. For instance, FIG. 5B is a topview of a component 10 where a portion of each ridge 20 is associated with a different pocket 18. Alternatively, the pockets 18 under different ridge 20 can be in communication. For instance, FIG. 5C illustrates a component 10 having a pocket 18 that extends under more than one ridge 20. The portion of the base 15 that defines the side of the pocket 18 supports the silica material 14 over the base 15.

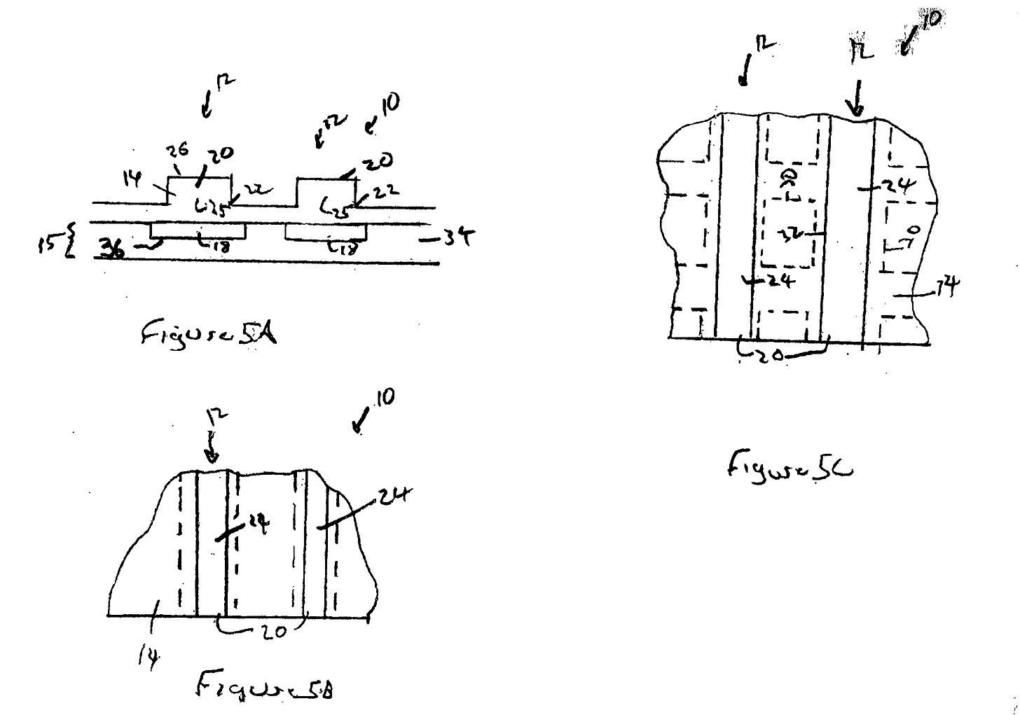

The light transmitting medium associated with adjacent waveguides can be separated by a gap 39 as shown in FIG. 6A and FIG. 6B. FIG. 6B is a topview of an optical component having two waveguides positioned adjacent to one another. FIG. 6A is a cross section of the component shown in FIG. 6B taken at the line labeled A. The gap 39 is partially defined by the base and one or more surfaces of the silica material 14 that intersect with the base. The one or more surfaces are shown as intersecting the base remote from a lateral side of the base although the one or more surfaces can intersect the base at a lateral side of the base so the lateral side 41 and the surface together define the lateral side of the component. The ridge of the waveguides can be centrally positioned between two surfaces 40 or can be off center relative to the surfaces 40. In some instances, the one or more surfaces are substantially perpendicular to the base.

When a component includes a single waveguide or waveguides that are not adjacent to one another, the silica material 14 may include surfaces 40 that intersect the base without forming a gap 39.

The surfaces 40 can provide isolation of the waveguides from one another and accordingly help reduce the amount of cross talk between adjacent waveguides. Light signals that exit the light signal carrying region can be reflected off the surface back into the waveguide or transmitted through the surface. Light signals transmitted through the surface can exit the gap into the atmosphere or be reflected off another surface of the groove. As a result, the amount of light that exits the light signal carrying region and enters another light signal carrying region is reduced. As a result, cross talk between adjacent waveguides is also reduced.

The base 15 extends away from the surface at an angle, φ less than 180 degrees. In other instances, the base 15 extends away from the surface at an angle, φ, less than 170 degrees, less than 140 degrees and less than 100 degrees. The base 15 preferably extends away from the surface at about 90 degrees. Accordingly, the base 15 serves as the bottom of the gap 39.

The gap 39 holds a medium that causes light signals from the silica material 14 to be reflected back into the silica material 14. For instance, the gap can hold ambient air. The low index of refraction of the ambient air causes reflection of the light signals are the surface 40. The gap can be filled with other media such as solids.

The surface extends along at least a portion of the longitudinal length of the waveguides. The longitudinal length is parallel to the direction of propagation of the light signals along the waveguide. In some cases the surface does not extend along the entire longitudinal length of the waveguide. For instance, when two waveguides intersect, the surface may intersect with the surface of another waveguide before the intersection of the light signal carrying regions associated with the waveguides.

In some instances, the surface 40 substantially traces the waveguide. For instance, the intersection of the surface 40 with the base can be substantially equidistant from a reference location that extends along the longitudinal length of the waveguide. When the waveguide is a ridge waveguide, a suitable reference point is the base of the ridge.

Although the gap is shown as extending only to the level of the base in FIG. 6A and FIG. 6B, the gap can extend into the base 15. For instance, FIG. 6C illustrates an embodiment of the component having a light transmitting medium 38 positioned in the pocket. The surfaces 40 extend through the light transmitting medium 38. Although not illustrated, the surfaces can also extend into the substrate.

The advantages provided by forming the surfaces in the silica medium can also be gained with traditional base constructions. For instance, FIG. 6D illustrates waveguides formed over a base having a continuous light barrier 99 formed over a substrate. The light barrier serves to reflect light signals from the waveguides 12 back into the waveguides 12. The surfaces 40 isolate the waveguides from one another.

The surfaces illustrated in the light transmitting medium of FIG. 6A through FIG. 6C can be employed in conjunction with other waveguide types such as channel waveguides. For instance, the surfaces can be formed in the light transmitting medium associated with the waveguide illustrated in FIG. 3A and FIG. 3B.

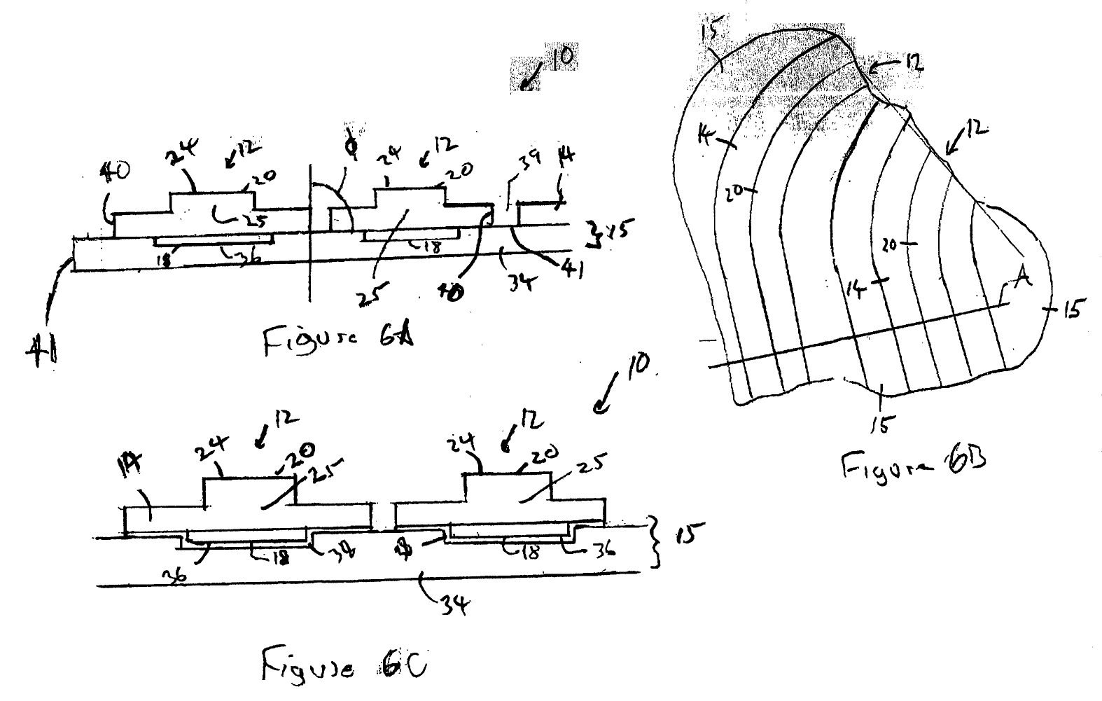

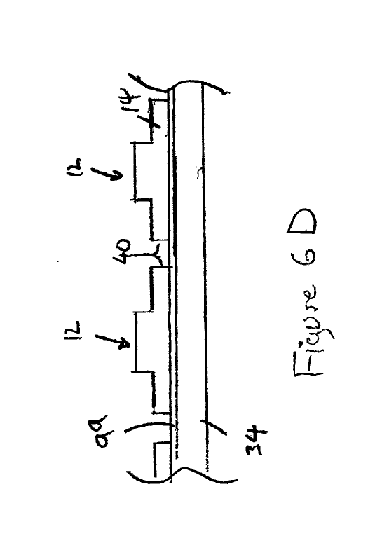

FIG. 7A to FIG. 7E illustrate a method for forming a component 10 having two waveguides. The method can be easily adapted to forming a component 10 having a single waveguide. A mask is formed on a substrate 34 so the portions of the substrate 34 where pockets 18 are to be formed are exposed. A suitable substrate 34 includes, but is not limited to, a silicon substrate 34. An etch is performed on the masked substrate 34 to form pockets 18 having the desired depth in the substrate 34. Although the pockets are illustrated as having a substantially rectangular shape, the pockets can be provided with a v-shape by performing a wet etch along the <111> crystal orientation of the substrate.

Air can be left in the pockets 18 or another material such as a low K material can be deposited in the pockets 18. The masks is then removed to provide the component 10 illustrated in FIG. 7A.

A light transmitting medium 38 can optionally be deposited over the substrate 34 as illustrated in FIG. 7B. The light transmitting medium 38 can be deposited so the light transmitting medium 38 is positioned in the pockets 18. Accordingly, the light transmitting medium 38 will have one or more surface 36 that define the pocket 18. The light transmitting medium and the substrate serve as the base 15.

A second light transmitting medium is positioned adjacent to the base. The second light transmitting medium can be grown on the base. Alternatively, wafer bonding techniques can be employed to attach a second light transmitting medium 42 such as a silica wafer 50 to the base 15 as shown in FIG. 7C. When a silica wafer is attached, a silicon layer 52 will typically be positioned over the silica. This silicon layer is removed to provide the component 10 shown in FIG. 7D. Suitable methods for removing the silicon layer include, but are not limited to, etching and polishing. Silica remains as the second light transmitting medium 42.

The second light transmitting medium 42 can be masked such that places where a ridge 20 is to be formed remain exposed. The component 10 is then etched and the mask removed so as to provide the component 10 shown in FIG. 7E.

The component of FIG. 7E can be further treated so as to form the surfaces 40 discussed with respect to FIG. 6A through FIG. 6D. For instance, the component can be masked such that the regions where a gap(s) is to be formed is exposed. When a gap will not be formed the component is masked so a side of the mask is aligned with the desired locations of the one or more surfaces 40. The exposed regions can then be etched and the mask removed so as to form the one or more surfaces 40 as shown in FIG. 7F. The surfaces are formed to the desired depth. Material(s) to be formed in the gap can be formed in the gap before and/or after removal of the mask. The sequence of forming the ridges and the one or more surfaces can be reversed from what is illustrated in FIG. 7E and FIG. 7F.

When a first light transmitting medium 38 is applied, a suitable first light transmitting medium 42 includes, but is not limited to, silica. Accordingly, the first light transmitting medium 38 and the second light transmitting medium 42 can both be silica. Additionally, the substrate 34 can also include a light transmitting medium such as silicon. When the first light transmitting medium 38 and the second light transmitting medium 42 are silica and the substrate 34 includes silicon, substantial reflection of light occurs at the intersection of the silicon dioxide and the silicon due to the change in index of refraction.

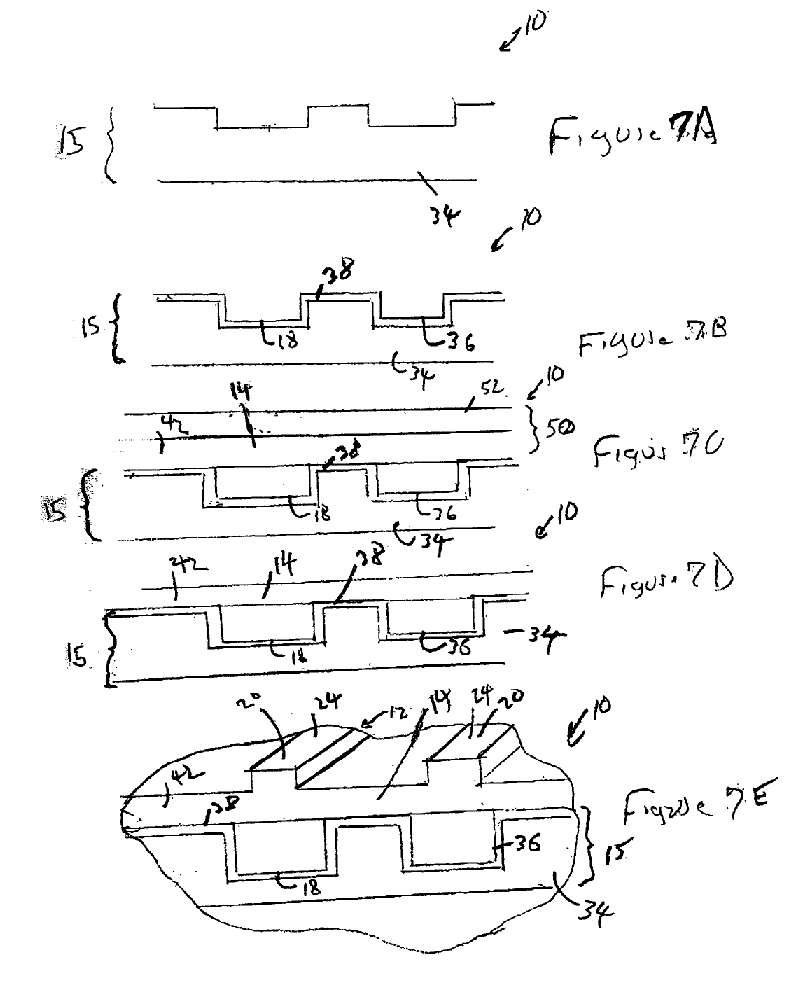

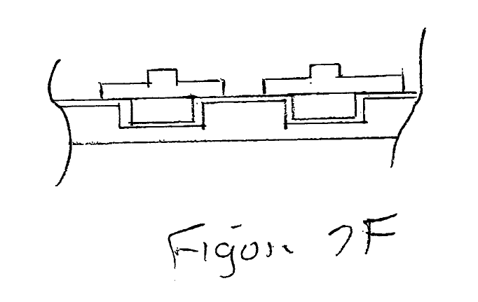

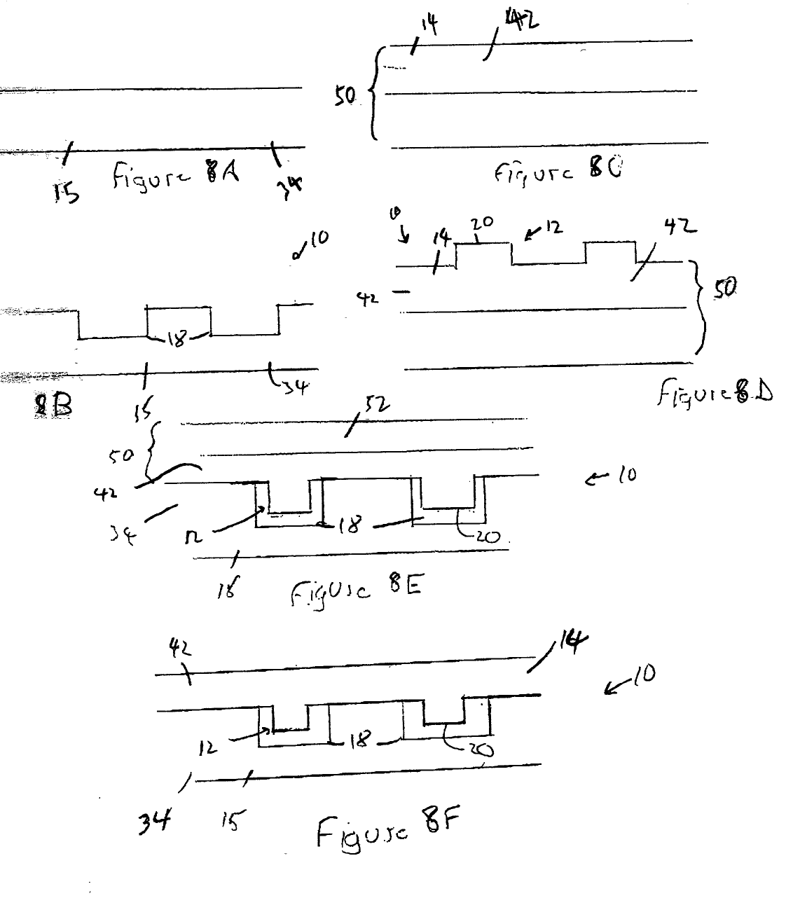

FIG. 8A through FIG. 8F illustrate a method of forming a component 10 having a ridge 32 positioned in a pocket 18. A substrate 34 is provided as shown in FIG. 8A. The substrate 34 is masked and etched to provide pockets 18 in the substrate 34 as shown in FIG. 8B. A light transmitting medium 42 is also provided as shown in FIG. 8C. Suitable light transmitting media 42 include, but are not limited to, the silica material 14 of a silica wafer 50. A silica wafer 50 typically includes a silicon layer 52 positioned adjacent to a layer of silica material 14. The silica wafer 50 is masked and etched so as to form ridges 20 in the light transmitting medium as shown in FIG. 8C. The ridges 20 are formed so as to be complementary to the pockets when the light transmitting medium is inverted. The silica wafer 50 is inverted and positioned over the substrate 34 with the ridges positioned in the pockets 18 as shown in FIG. 8E. Wafer bonding techniques are employed to bond the silica wafer 50 to the substrate 34. The silicon layer 52 can be removed to provide the component 10 shown in FIG. 8F. Suitable methods for removing the silicon layer 52 include, but are not limited to, etching and polishing. Although the method illustrated in FIG. 8A through FIG. 8F shows fabrication of an optical component 10 having a plurality of waveguides, the method is easily adapted for formation of an optical component having one waveguide.

When a second ridge is to be formed in the light transmitting medium as shown in FIG. 3C, the top of the second light transmitting medium 42 in FIG. 8F can be masked and etched to provide the component with the second ridge.

FIG. 9A through FIG. 9H illustrates a method for forming an optical component having an alignment region 48. FIG. 9A is a cross section of an optical component 10 taken along the length of the waveguide. The base of the ridge is illustrated as a dashed line extending along the length of the waveguide 32. FIG. 9B is a cross section of the component 10 shown in FIG. 9A taken at the line labeled A. The component 10 illustrated in FIG. 9A can be fabricated using the method of FIG. 7A through FIG. 7E or FIG. 8A through FIG. 8F. The component 10 is fabricated to have a waveguide 12 that extends all the way to the edge of the component. A mask 54 is formed on the component 10 such that the ridge 32 of the waveguide 12 over the alignment region 48 remains exposed as evident in FIG. 9B.

An etch is performed on the exposed regions of the component 10 illustrated in FIG. 9A and FIG. 9B and the mask 54 is removed to provide the component 10 illustrated in FIG. 9C and FIG. 9D. FIG. 9C is a cross section of the optical component 10 taken along the length of the waveguide 12 and FIG. 9D is a cross section of the component 10 shown in FIG. 9C taken at the line labeled A. The etch is performed so as to bring the ridge 32 flush with the side of the component 10 as evident in FIG. 9D. Accordingly, the etch results in the formation of an upper region of the facet 44A.

A mask 54 is formed over a region of the component 10 as illustrated n FIG. 9E and FIG. 9F. FIG. 9E is a cross section of an optical component 10 taken along the length of the waveguide 12 and FIG. 9F is a cross section of the component 10 shown in FIG. 9C taken at the line labeled A. The region of the component 10 where the self-alignment region will be formed remains exposed.

The exposed region is etched to provide the optical component illustrated in FIG. 9G and FIG. 9H. FIG. 9G is a cross section of an optical component taken along the length of the waveguide and FIG. 9H is a cross section of the component shown in FIG. 9G taken at the line labeled A. The region is etched until the self-alignment region 48 is exposed. Accordingly, the etch forms a lower region of the facet.

An alternative method for forming the component illustrated in FIG. 9G and FIG. 9H is forming the light transmitting medium on the base such that the edge of the light transmitting medium is not aligned with the edge of the base. Accordingly, the light transmitting medium is formed so as to leave the alignment region 48 exposed. This arrangement can be achieved by bonding the silica wafer 50 such that the base 15 extends beyond the edge of the silica wafer 50.

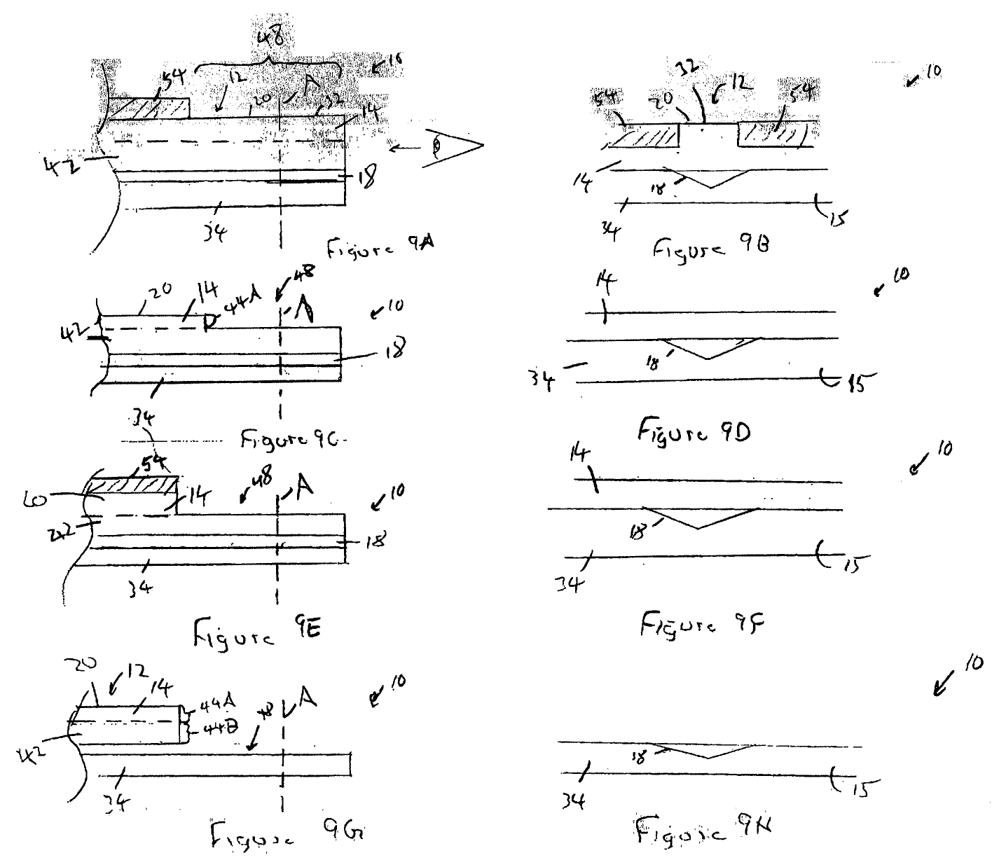

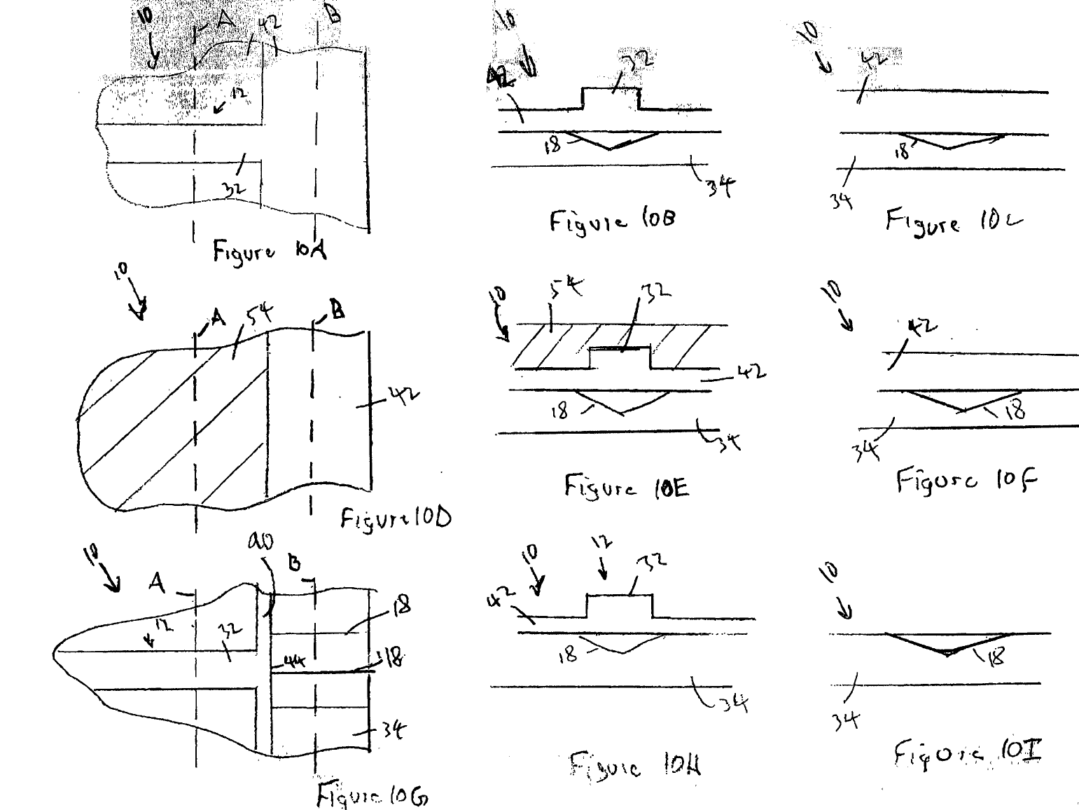

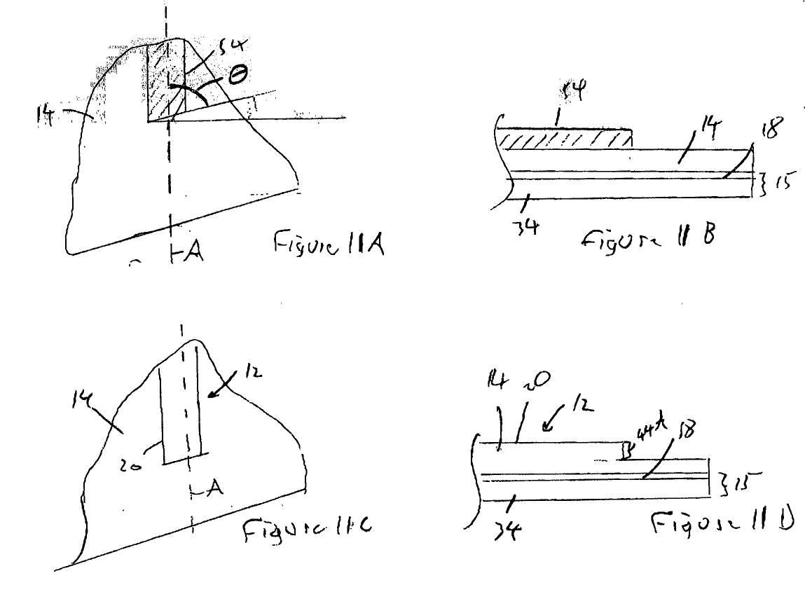

FIG. 10A through FIG. 10I illustrate another embodiment of a method for forming an optical component 10 having an alignment region 48 configured to align an optical fiber with a facet 44 of a waveguide 12. The method of FIG. 10A through FIG. 10F allows the alignment region 48 to be formed with a single etch. Accordingly, the need to achieve perfect alignment of subsequently formed masks is eliminated.

FIG. 10A is a topview of an optical component 10. FIG. 10B is a cross section of the component 10 shown in FIG. 10A taken at the line labeled A and FIG. 10C is a cross section of the component 10 shown in FIG. 10A taken at the line labeled B. The component 10 of FIG. 10A through FIG. 10C could be fabricated using the method of FIG. 7A through FIG. 7E or FIG. 8A through FIG. 8F. The component 10 is fabricated with the ridge 32 of the waveguide 12 extending over the alignment region 48. The ridge 32 of the waveguide 12 and the ridge 32 over the alignment region 48 can be concurrently formed during a single etch.

A mask 54 is formed such that at least a portion of the alignment region 48 remains exposed as shown in FIG. 10D through FIG. 10F. FIG. 10D is a topview of the optical component 10. FIG. 10E is a cross section of the component 10 shown in FIG. 10D taken at the line labeled A and FIG. 10F is a cross section of the component 10 shown in FIG. 10D taken at the line labeled B. The mask 54 can overlap the ridge 32 over the alignment region 48 or can be aligned with the edge of the ridge 32 over the alignment region 48.

An etch is performed on the exposed regions of the optical component 10 and the mask 54 removed to provide the component 10 shown in FIG. 10G through FIG. 10I. FIG. 10G is a topview of the optical component 10. FIG. 10H is a cross section of the component 10 shown in FIG. 10G taken at the line labeled A and FIG. 10I is a cross section of the component shown in FIG. 10G taken at the line labeled B. The etch is performed until the pocket 18 in the alignment region 48 is exposed. Accordingly, the etch forms the entire side of the facet 44. A flange 90 is formed adjacent to the facet 44 of the waveguide because the mask overlapped the ridge over the alignment region. Reducing the amount of overlap reduces the thickness of the flange. Additionally, the flange 90 can be eliminated by aligning the mask 54 with the edge of the ridge 32 over the alignment region 48.

The pocket positioned adjacent to the light signal carrying region in the methods of FIG. 9A through FIG. 9H and/or FIG. 10A through FIG. 10I can also extend into the alignment region. As a result, a single pocket serves to hold a material that reflects light from the light signal carrying region and to align an optical fiber with the facet. Because a single pocket serves both purposes, the pocket in the alignment region is centered relative to the facet by centering the ridge over the pocket. As a result, there is no need for an additional step of aligning a pocket with the facet.

The methods of FIG. 9A through FIG. 9H and/or FIG. 10A through FIG. 10I is easily adapted to form an angled facet by forming the mask(s) at an angle relative to the longitudinal axis of the ridge.

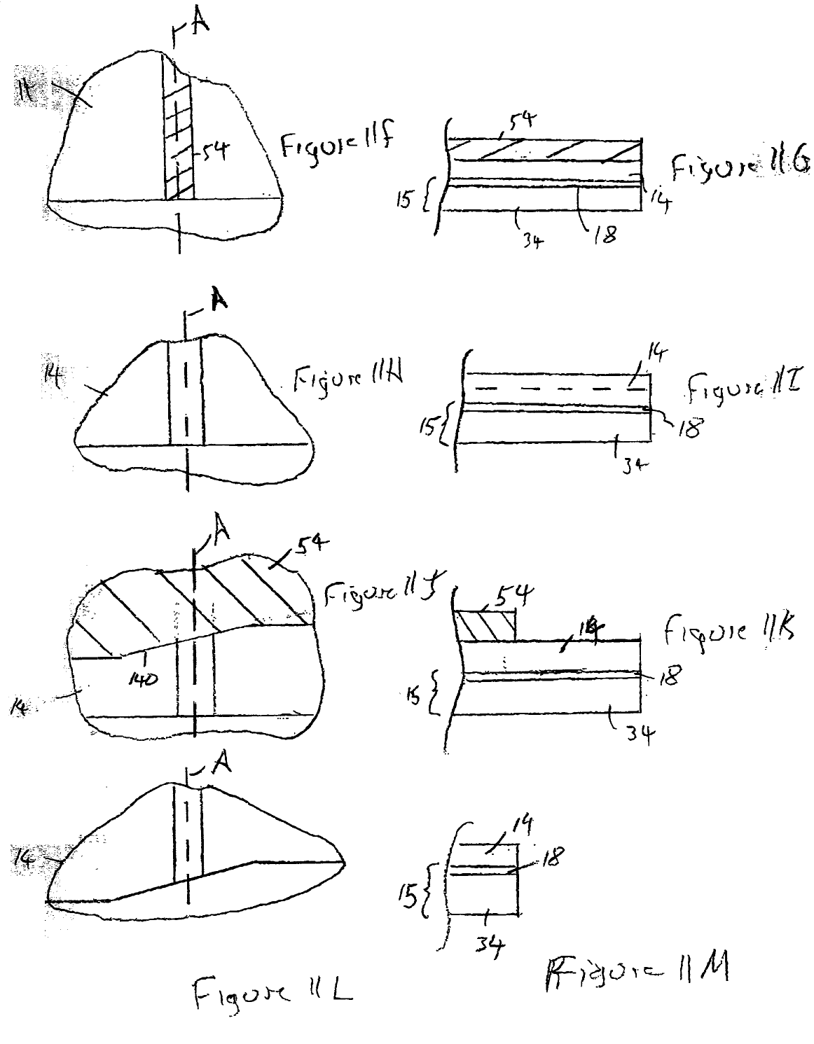

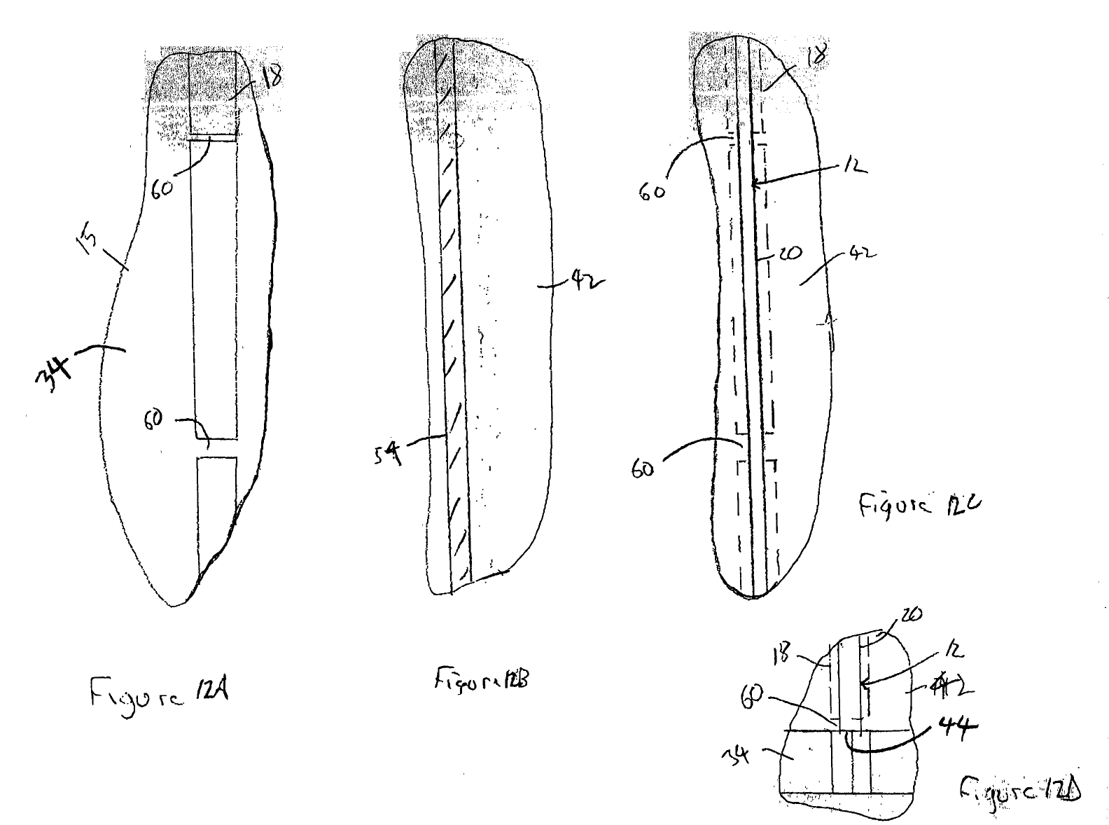

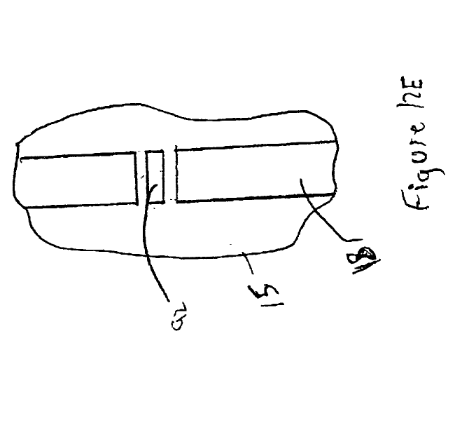

FIG. 11A through FIG. 11D illustrate a method of forming the component 10 illustrated in FIG. 9C and FIG. 9D with a facet that is angled relative to the direction of propagation of light signals traveling along the waveguide. The component 10 in FIG. 11A is a topview of a component 10. The illustrated component 10 could be fabricated according to the method illustrated in FIG. 7A through FIG. 7D. FIG. 10B is a sideview of the component 10 of FIG. 11A taken along the line labeled A. A mask 54 is formed on the component 10 as shown in FIG. 11A. The mask 54 covers the region where the ridge is to be formed. A side of the mask 54 has an angle φ less than ninety degrees relative to the longitudinal axis of the waveguide, or less than ninety degrees relative to the direction of propagation of light signals traveling along the waveguide.

An etch is performed on the exposed regions of the component 10 and the mask 54 removed to provide the component 10 illustrated in FIG. 11C and FIG. 11D. The etch concurrently forms the sides of the ridge 32 and an upper region of a facet 44A. The angle θ of the mask results in the upper region of the facet 44A having an angle θ. As described above, a facet 44 having an angle θ can improve performance of the component 10. The method of FIG. 9E through FIG. 9H can be employed using another mask having a side angled relative to the direction of propagation to complete fabrication of the lower region of the facet 44A and the alignment region 48.

FIGS. 11F through FIG. 11M illustrate another method of forming an optical component with an angled facet. The illustrated method allows for formation of the facet without the need to align sequentially formed masks. The method is suitable for use in forming a component without an alignment region although the method can be adapted to formation of an optical component having an alignment region.

FIG. 11F is a topview of a component 10. The illustrated component 10 could be fabricated according to the method illustrated in FIG. 7A through FIG. 7D. FIG. 11G is a sideview of the component 10 of FIG. 11A taken along the line labeled A. A mask 54 is formed on the component 10 as shown in FIG. 11F. The mask 54 covers the region where the ridge is to be formed presuming that the ridge is to extend to the side of the component.

An etch is performed and the mask 54 removed to provide the component shown in FIG. 11H and FIG. 11I. FIG. 11H is a topview of the component 10 and FIG. 11I is a sideview of the component 10 of FIG. 11H taken along the line labeled A. The etch results in formation of the sides of the ridge. The base of the ridge is illustrated as a dashed line in FIG. 11I.

A second mask 54 is formed to provide the component shown in Figure shown in FIG. 11J and FIG. 11K. FIG. 11J is a topview of the component 10 and FIG. 11K is a sideview of the component 10 of FIG. 11J taken along the line labeled A. A side 140 of the mask where the facet will be formed is angled at less than ninety degrees relative to the longitudinal axis of the waveguide. The side of the mask that is not located where the mask will be formed can have any angle relative to the longitudinal axis or can be angled so as to account for facets to be formed on other waveguides. For instance, the side of the mask can have a zig zag pattern over a plurality of waveguides to provide facets as illustrated in FIG. 4H.

An etch is performed and the second mask 54 removed to provide the component illustrated in FIG. 11L and FIG. 11M. FIG. 11L is a topview of the component 10 and FIG. 11M is a sideview of the component 10 of FIG. 11L taken along the line labeled A. The etch results in the formation of the entire facet. Accordingly, the etch can be performed completely through the component. Alternatively, the etch can be formed through the light transmitting medium and into the base. Non-etch based methods can be employed to remove the remaining portions of the base. For instance, the remaining portions of the base can be removed by etching, milling or cutting. Alternatively, another base etch can be employed to remove the remaining portions of the base. The etch employed to remove the remaining portions of the base can cruder than the etch employed to form the facet.

Different mask and etch steps can be performed during the formation of the pockets on the base 15 to provide a pocket having a different shape in the alignment region than adjacent to the light signal carrying region(s). As a result, the shape of the pocket adjacent to the light signal carrying regions can be selected to optimize carrying of the light signal while the pocket in the alignment region can be shaped to optimize alignment of the optical fiber and the facet.

In the methods described above, the alignment region is fabricated such that enough of the pocket is exposed to provide alignment of an optical fiber relative to the waveguide. Alternatively, the above methods can be employed to expose a region of the base which is larger than the desired size of the alignment region. Cutting techniques such as milling and/or laser cutting can be used to cut through the exposed base such that an alignment region having the desired shape is formed. Alternatively, an etch can be performed through the base so as to form an alignment region having the desired shape. Additionally, U.S. patent application Ser. No. (not yet assigned); filed on Oct. 16, 2000; and entitled “Formation of a Smooth Vertical Surface on an Optical Component” teaches a suitable method for severing the exposed base. These techniques result in formation of the edge of the component.

Many of the methods described above employ wafer bonding techniques. Suitable wafer bonding techniques include, but are not limited to, techniques employing elevated temperature and/or pressure. Additionally, microwave assisted wafer bonding techniques can be employed.

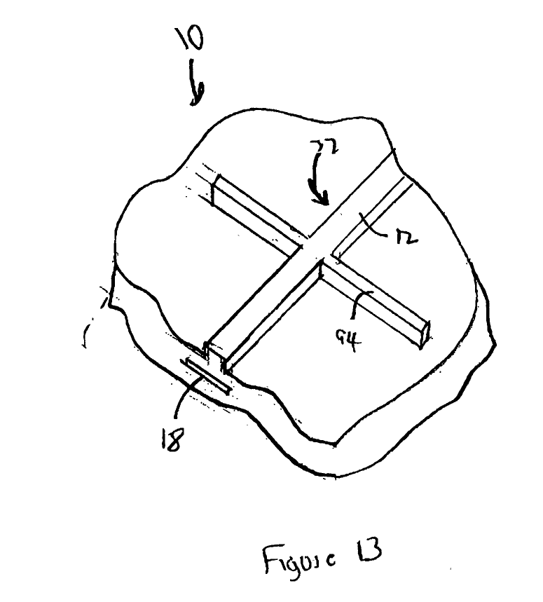

As noted above, the pocket 18 can hold a gas under vacuum. FIG. 12A through FIG. 12C teach a method for forming a pocket holding a gas under vacuum. FIG. 12A is a topview of a base 15 having a pocket 18 formed in a substrate 34. The component 10 includes two or more sealing members 60 that extend across the pocket 18. The sealing members 60 can be portions of the base 15 that are masked as the pocket 18 is formed.

A light transmitting medium is formed over the base as shown in FIG. 12B. As discussed above, the light transmitting medium can be formed over the base by employing wafer bonding techniques to bond a wafer to the base. During the bonding process the sealing members are bonded to the light transmitting medium. The air in the pocket during the wafer bonding process remains sealed in the pocket.

A mask 54 is formed over the regions of the silica material 14 where ridges 32 are desired as shown in FIG. 12B. An etch is performed so as to form the sides of the ridge 32 and the mask 54 removed to provide the component 10 shown in FIG. 12C. Although the outline of the pocket is not necessarily visible in a topview of the component, the outline of the pocket is illustrated as a dashed line in FIG. 12C.

As will be evident from the following discussion, the vacuum can be formed in the pocket before, during or after formation of the ridge.

The vacuum can be formed by heating the component 10 to react the oxygen in the sealed pocket(s) 18 with the light transmitting medium and/or the base. For instance, when the pockets are formed in a silicon substrate and the gas in the pocket is air, the oxygen in the air can react with the silicon to form silica. Heating the component can be for the purpose of catalyzing the reaction or can be part of a fabrication step such as bonding the light transmitting medium to the base. The reaction of the oxygen results in a vacuum because the amount of gas in the seal pocket is reduced. When one or more layers of a light transmitting medium 38 are formed in the pocket, the light transmitting medium can be selected so as to catalyze the reaction between the gas in the pocket and the light transmitting medium 38.

A vacuum can also be formed in the pocket by forming the light transmitting medium adjacent to the base in a chamber held under vacuum. The pressure in the pocket will be substantially the same as the pressure in the chamber. The pressure in the pocket can be reduced further by heating the pocket to react the material in the pocket with the light transmitting medium or the sides of the pocket.

The above methods of forming a vacuum can be employed to provide the material in the pocket with a pressure of less than about 1 atmospheres (atm), 0.95 atm, 0.9 atm, 0.85 atm, 0.8 atm, 0.75 atm, 0.7 atm, 0.6 atm, 0.5 atm or 0.4 atm.

FIG. 12D illustrates the position of a sealing member 60 positioned adjacent to the facet of a waveguide 12. The sealing member is positioned so a portion of the sealing member and the facet form a continuous surface. Positioning sealing members adjacent to the facet 44 can increase the portion of the waveguide adjacent to a pocket 18 under vacuum.

Each pocket 18 must include at least two sealing members 60 in order for the vacuum to be formed. When a pocket 18 includes two sealing members 60, the sealing members 60 are preferably positioned adjacent to the ends of the waveguide 12 in order to increase the portion of the waveguide 12 adjacent to a pocket 18 under vacuum. When a pocket includes more than two sealing members, the pocket is divided into a plurality of sub-pockets. The sealing members can help support the ridge over the pocket. Accordingly, more than two sealing members can be advantageous in longer waveguides. The sealing members can be periodically positioned along the length of the waveguide 32.

A portion of the base serves as the sealing members in the above illustrations. Alternatively, the sealing member can be an adhesive such as an epoxy, glue or other sealing material that transitions from a fluid to a solid. The fluid sealing member can be positioned in selected portion of the pocket before the light transmitting medium 42 is formed over the base. Alternatively, a fluid epoxy can be injected into the pocket after the light transmitting medium is formed over the base. Injecting the fluid epoxy into the pocket can be advantageous when forming the optical component with a ridge in the pocket because the fluid can flow around the ridge to seal the pocket.

Once a fluid sealing member is positioned in the pocket, the fluid can transition into a solid material that is bonded to the pocket and the light transmitting medium. Suitable fluid sealing members include, but are not limited to, epoxies that cure at room temperature or upon heating. Additionally, the fluid preferably transforms to an air-tight or gas impermeable solid in order to preserve the vacuum in the pocket. In some instances, the solid form of the material has thermally insulating properties in order to provide additional thermal isolation of the waveguide. The sealing member can also be a material that retains an amorphous state such as a putty.

The sealing member can be a combination of the base and a sealing material that transitions from a fluid to a solid as shown in FIG. 12E. Two portions of the base extending across a pocket can be spaced apart. A well 92 is formed between the spaced apart portions of the base. A fluid sealing material can be positioned in the well 92 before the light transmitting medium is formed adjacent to the base. Alternatively, the fluid sealing material can be delivered into the well 92 after the light transmitting medium is formed adjacent to the base. The portion of the base extending across the pocket and/or the sealing material can bond with the light transmitting medium. In some instances, the well 92 serves to retain the sealing material is an isolated region of the pocket.

Although FIG. 12A through FIG. 12E is discussed in the context of air in the pocket, a vacuum can be formed using another gas in the pocket. For instance, when wafer bonding is performed, the wafer bonding can be performed in a chamber filled with a gas other than air. As a result, the pocket will be filled with a gas other than air. The gas can be selected to catalyze reaction between the gas and the sides of the pocket and accordingly increase the level of vacuum. Additionally, the chamber can be under vacuum to provide additional vacuum to the pocket.

A waveguide 12 can include one or more support ridges 94 as shown in FIG. 13. The one or more support ridges extend outward from the ridge 32 of the waveguide 12. The support ridge 94 preferably extends across the light signal carrying region and can extend across the pocket 18. The support ridges 94 are sized and positioned to overcome the effects of a vacuum in the pocket 18 on the ridge 32 of the waveguide 12. The one or more support ridges 94 can also be used when a vacuum is not formed in the pocket. The support ridges 94 need not have the same width as the ridges 12 of the waveguide 32. Further, a narrower support ridge is typically associated with less optical loss than a broader support ridge. The support ridges 94 can be used in conjunction with or in place of sealing members configured to provide support to the ridge. The support ridges can be formed concurrently with the ridges of the waveguide.

Waveguides according to the present invention can be used in conjunction with optical components 10 that employ waveguides. For instance, the waveguides can be with switches, filters, tunable filters, modulators, gain equalizers, fibers dispersion compensators and arrayed waveguide gratings. As an example, the waveguide 12 can be used in conjunction with the switch described in U.S. Pat. No. 5,581,643.

Although the waveguides disclosed above include the silica material as a light transmitting medium, the waveguide can be constructed from other light transmitting media such as silicon, GaAs, SiGe, silicon InP, LiNbO₃, SiO₂, polymers, liquid crystal, SiNx and SiONx. These materials can also be used as the light transmitting medium 38 formed in the pockets. Suitable substrates include, but are not limited to, silicon, GaAs, InP, LiNbO3, silica, sapphire, plastic, graphite and steel.

Many of the etches employed in the methods described above result in formation of a facet 44 that will be in optical communication with the waveguide 12 and/or in formation of the sides of a waveguide 12. These etches are preferably provide a smooth facet 44 and waveguide sides in order to reduce scatter and reflection. Suitable etches for forming these surfaces include, but are not limited to, reactive ion etches, the Bosch process and the methods taught in U.S. patent application Ser. No. (not yet assigned); filed on Oct. 16, 2000; and entitled “Formation of a Smooth Vertical Surface on an Optical Component” which is incorporated herein in its entirety. A single component can be fabricated using combinations of these methods.

The substrate 34 and the second light transmitting medium 42 can be the same material. For instance, the substrate 34 and the second light transmitting medium 42 can both be silicon. Additionally, the light transmitting medium 38 need not be positioned in the pocket. In such an embodiment, the transition from the base to the light transmitting medium is often not physically visible. For instance, the line labeled D in FIG. 1B illustrates the division between the base and the light transmitting medium. The line labeled D in FIG. 3A also illustrates the division between the base and the light transmitting medium. However, these lines may not be physically observable when the light transmitting medium and the substrate (or base) are constructed from the same material.

Embodiments of the component where the second light transmitting medium and the base are the same material can be advantageous because light signals that escape from a light signal carrying region can enter the substrate or the base through the gap between the pockets. Accordingly, these light signals are drained from the waveguides and are less likely to be a source of cross talk by entering other waveguides. Other component constructions providing this drain effect can be achieved with other component constructions. For instance, the drain of light signals results from a base that does not reflect all of the light signals that are incident on the base from the adjacent second light transmitting medium.

The components and/or methods disclosed above can be used in conjunction with other component and/or waveguide constructions such as the constructions shown in U.S. patent application Ser. No. (not yet assigned), filed on Oct. 10, 2000, entitled “Waveguide Having a Light Drain” and incorporated herein in its entirety.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

What is claimed is:

1. An optical component, comprising:
a base; and
a plurality of waveguides defined in a light transmitting medium, the light transmitting medium positioned adjacent to the base such that the light transmitting medium associated with at least two adjacent waveguide is separated by a gap.

2. The component of claim 1, wherein the gap is filled with ambient air.

3. The component of claim 1, wherein the gap contains a medium that causes a light signal from the adjacent light transmitting medium to be reflected back into the adjacent light transmitting medium.

4. The component of claim 1, wherein the gap is at least partially defined by a surface of the light transmitting medium that intersects with the base.

5. The component of claim 4, wherein the at least one surface extends along at least a portion of a longitudinal length of the waveguides.

6. The component of claim 5, wherein the intersection of the surface with the base is substantially equidistant from the waveguides along the portion of the longitudinal length of the waveguides.

7. The component of claim 1, wherein the base includes one or more pockets and the waveguides are each positioned adjacent to a pocket.

8. The component of claim 7, wherein the one or more pockets each hold a medium under vacuum.

9. The component of claim 1, wherein each waveguide includes a ridge formed in the light transmitting medium.

10. An optical component, comprising:
a base; and
a waveguide having a waveguide defined in a light transmitting medium positioned adjacent to the base, the light transmitting medium including a surface that intersects the base and extends along at least a portion of the lateral length of the waveguide.

11. The component of claim 10, wherein the surface intersects with the base at a location substantially remote from a lateral side of the base.

12. The component of claim 10, wherein a location where the surface intersects the base substantially traces the waveguide along at least the portion of the longitudinal length of the waveguide.

13. The component of claim 12, wherein the location where the surface intersects the base is substantially equidistant from the waveguide along at least a portion of the longitudinal length of the waveguide.

14. The component of claim 10, wherein the surface is adjacent to ambient air.

15. The component of claim 10, wherein the surface is substantially perpendicular to the base.

16. The component of claim 10, wherein the base includes a pocket and the waveguide is positioned adjacent to a pocket.

17. The component of claim 16, wherein the pocket holds a medium under vacuum.

18. The component of claim 10, wherein the waveguide includes a ridge formed in the light transmitting medium.

19. A method of fabricating an optical component, comprising:
obtaining a base and a light transmitting medium positioned adjacent to the base, a waveguide being defined in the light transmitting medium; and forming a surface that intersects the base in the light transmitting medium such that the surface extends along at least a portion of a longitudinal length of the waveguide.

20. The method of claim 19, wherein the surface is formed such that the surface intersects the base at a location remote from a lateral side of the base.

21. The method of claim 19, wherein the surface is formed such that a location of the intersection between the surface and the base is substantially equidistant from the waveguide along at least a portion of the length of the waveguide.

22. A method of fabricating an optical component, comprising:
obtaining a base with a light transmitting medium positioned adjacent to the base;
forming a surface in the light transmitting medium such that at least a portion of the surface intersects with the base; and
defining a waveguide in the light transmitting medium such that the surface extends along at least a portion of a longitudinal length of the waveguide.

23. The method of claim 22, wherein defining a waveguide in the light transmitting medium includes forming a ridge in the light transmitting medium.

24. The method of claim 22, wherein the waveguide is formed such that the surface intersects the base remote from a lateral side of the base.

25. The method of claim 22, wherein the waveguide is formed such that a location of the intersection between the surface and the base is substantially equidistant from the waveguide along at least a portion of the length of the waveguide.
